(19) United States
(12) Patent Application Publication
(10) Pub. No.: US 2005/0089099 A1
(43) Pub. Date: Apr. 28, 2005

(54) Fast motion estimating apparatus

(75) Inventor: Jae-hun Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/956,375

(22) Filed: Oct. 4, 2004

(30) Foreign Application Priority Data
Oct. 4, 2003 (KR) 2003-69020

(51) Int. Cl. H04N 7/12

(52) U.S. Cl. 375/240.16; 375/240.12; 375/240.24

(57) ABSTRACT

A fast motion estimating apparatus including a merging unit which merges differences for respective basic blocks separated from a macro block to calculate differences for blocks of various sizes; and a best motion estimation block determining unit which determines blocks performing a best motion estimation according to the differences for the blocks of various sizes calculated by the merging unit, wherein it a fast motion estimating apparatus using image blocks of various sizes is implemented in real time even when an input picture has a standard definition format.

### CROSS-REFERENCE TO RELATED APPLICATION

This application claims the benefit of Korean Patent Application No. 2003-69020, filed on Oct. 4, 2003, in the Korean Intellectual Property Office, the disclosure of which is incorporated herein in its entirety by reference.

### BACKGROUND OF THE INVENTION

1. Field of the Invention

The present invention relates to a fast motion estimating apparatus that uses image blocks of various sizes.

2. Description of the Related Art

The newly established ITU-T H.264 (ISO/IEC MPEG-4 AVC) standard employs a compression format for digital video based on using image blocks of various sizes and requires corresponding motion estimation method. In video codec (compression and decompression), motion estimation, more specifically, motion estimation using image blocks of various sizes, is complex and requires a large amount of calculation. Therefore, fast motion estimation algorithms and efficient hardware structures are necessary. Accordingly, the invention relates to an effective hardware structure for implementing a fast motion estimation algorithm.

Conventionally, a lot of calculation is required when performing motion estimation using image blocks of various sizes via a full search method,. Therefore, in view of hardware and hardware performance, i.e., a chip size, a power consumption, etc., it is very expensive to manufacture a hardware structure for encoding and decoding image blocks of various sizes in real time.

As a result, fast motion estimation algorithms using a partial search method have been developed. However, optimal hardware structures for implementing these algorithms have not been developed yet. Input pictures in a common image format (CIF) with a resolution of 352×288 are input at 30 Hz per frame and can be processed in real time when using conventional hardware structures. However, the input pictures in a standard definition (SD) format with a resolution of 720×480 are input at 30 Hz per frame and cannot be processed in real time when using the conventional hardware structures.

### SUMMARY OF THE INVENTION

The invention provides a fast motion estimating apparatus using image blocks of various sizes, which can process in real time input pictures in a standard definition (SD) format, by repeatedly using a minimum number of computing elements and memory elements.

According to an aspect of the invention, there is provided a fast motion estimating apparatus including: a sum of absolute differences (SAD) merging unit which merges SADs of lower level basic blocks that are a basic unit separated from a predetermined macro block to calculate SADs of image blocks of various sizes; and a best motion estimation block determining unit which determines a block of a mode performing a best motion estimation using image blocks of various sizes of which SADs are calculated by the SAD merging unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a fast motion estimation algorithm used with an embodiment of the invention;

FIG. 2 is a block diagram illustrating a fast motion estimating apparatus according to an embodiment of the invention;

FIG. 3 is a diagram illustrating basic blocks and a search area corresponding to the basic blocks according to an embodiment the invention;

FIG. 4 is a diagram illustrating a structure of a basic search unit shown in FIG. 2;

FIG. 5 is a diagram illustrating a search sequence of a partial search used for an embodiment of the invention;

FIG. 6 is a diagram illustrating an array for calculating a sum of absolute differences (SAD) at a position of (−2, −2) in FIG. 5;

FIG. 7 is a diagram illustrating an array for calculating an SAD at a position of (−1, −2) in FIG. 5;

FIG. 8 is a diagram illustrating an array for calculating an SAD at a position of (0, −2) in FIG. 5;

FIG. 9 is a diagram illustrating an array for calculating an SAD at a position of (1, −2) in FIG. 5;

FIG. 10 is a diagram illustrating an array for calculating an SAD at a position of (2, −2) in FIG. 5;

FIG. 11 is a diagram illustrating an array for calculating an SAD at a position of (2, −1) in FIG. 5;

FIG. 12 is a diagram illustrating an array for calculating an SAD at a position of (1, −1) in FIG. 5; and

FIG. 13 is a block diagram illustrating a structure of an SAD merging unit shown in FIG. 2.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

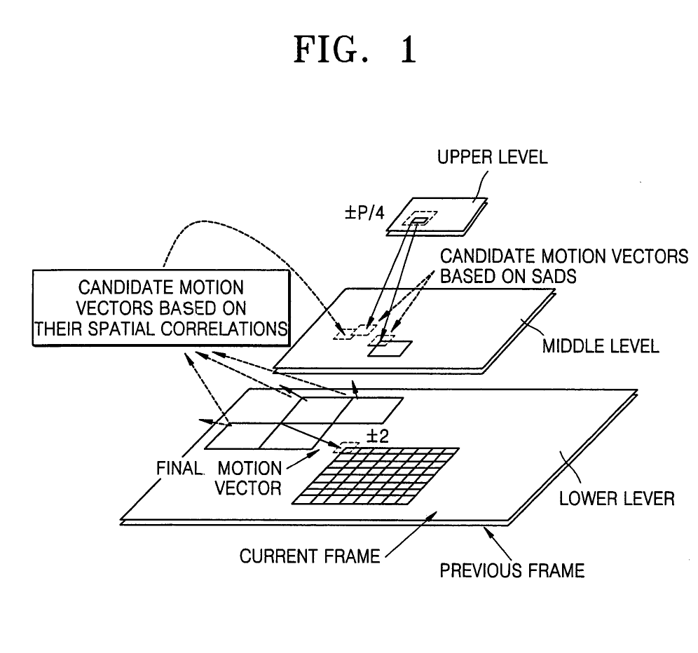

FIG. 1 is a diagram illustrating a fast motion estimation algorithm used for an aspect of the invention. In FIG. 1, the fast motion estimation algorithm includes at least an upper level, a middle level, and a lower level.

A picture of the lower level is an original picture having an original size, a picture of the middle level is a picture obtained by vertically and horizontally lessening the size of the original picture into a half (½), and a picture of the upper level is a picture obtained by vertically and horizontally lessening the size of the original picture into a quarter (¼). On these pictures, a full search is performed at the upper level, and partial searches are sequentially performed at the middle level and the lower level by using motion vectors obtained from a previous level as search points, so that a final motion vector is obtained through such finer adjustment.

Specifically, at the upper level, a search is performed by using the picture having a quarter (¼) of the vertical size and a quarter (¼) of the horizontal size of the original picture. That is, the full search is performed in a 4×4 block unit on a pixel area of the vertical and horizontal sizes are scaled by ±p/4, where p is a search range. After the upper level search, two points, of which a sum of absolute differences (SAD) is minimum, are selected as upper level candidate motion vectors for a middle level search.

At the middle level, a search is performed by using the pictures having a half (½) of a vertical size and the half (½) of the horizontal size of the original picture. That is, the partial search is performed in an 8×8 block unit on a pixel area of which the vertical and horizontal sizes are scaled by ±2 pixels, by using each of the three upper level candidate motion vectors as initial search points. Out of the three initial search points, two are selected from the upper level search, and the other one is selected on the basis of spatial correlations between the motion vectors. When the middle level search is performed centering on the three initial search points and a point having the minimum SAD is thus obtained, respectively, the point having the minimum SAD is selected as an initial search point for the lower level search.

At the lower level, a search is performed by using the original picture itself. That is, the partial search is performed in a 16×16 block unit on a pixel area of which the vertical and horizontal sizes are scaled by ±2 pixels, centering on the initial search point selected in the middle level search.

Finally, the SADs are obtained in a 4×4 block unit, and the SADs of image blocks of various sizes such as 4×8, 8×4, 8×8, 16×8, 8×16 and 16×16 are obtained by using the SADs of the 4×4 blocks.

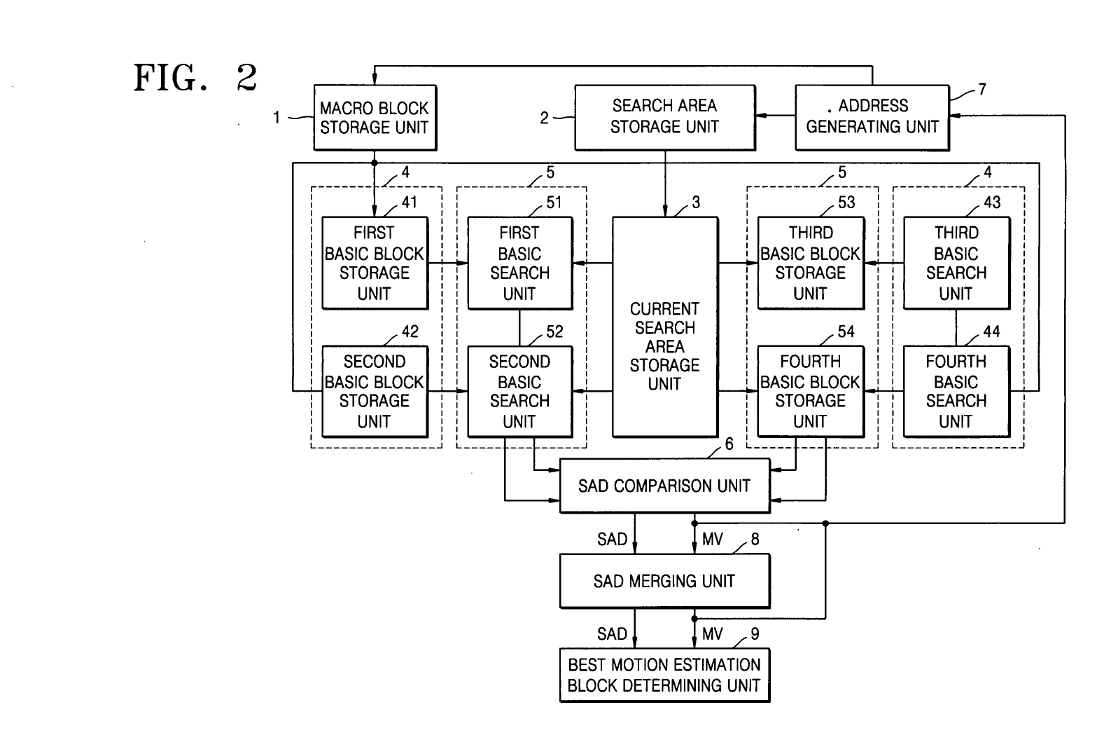

FIG. 2 is a block diagram illustrating a fast motion estimating apparatus according to an aspect of the invention. In FIG. 2, the fast motion estimating apparatus includes a macro block storage unit 1, a search area storage unit 2, a current search area storage unit 3, a basic block storage unit 4, a basic search unit 5, an SAD comparison unit 6, an address generating unit 7, an SAD merging unit 8, and a best motion estimation block determining unit 9.

The macro block storage unit 1 extracts a macro block from a current frame, and stores the extracted macro block. Here, the macro block refers to a block that is a unit for encoding and decoding in MPEG.

The search area storage unit 2 extracts a search area of the macro block from a previous frame, and stores the extracted search area. At that time, if a wider search area is searched, a more accurate motion estimation can be performed, but an amount of calculation is increased.

The current search area storage unit 3 extracts an upper level search area from the search area stored in the search area storage unit 2, and stores the extracted upper level search area, where the upper level search area has a resolution that is lower than the resolution of the macro block. In order to reduce the amount of calculation for the motion estimation, the upper level search area having a smaller vertical size and a smaller horizontal size are obtained by lowering the resolution of the search area.

The basic block storage unit 4 extracts upper level basic blocks from the macro block stored in the macro block storage unit 1, and stores as many of the extracted upper level basic blocks as the number of simultaneous search units, where the upper level basic blocks have the same resolution as the upper level search area. The resolutions of both pictures to be compared with each other for the motion estimation should be equal to each other. Therefore, for example, the upper level basic blocks having the same resolution as the upper level search area are obtained by lowering the resolution of the macro block.

The basic search unit 5 calculates SADs between the respective upper level basic blocks stored in the basic block storage unit 4 and respective areas corresponding to the respective upper level basic blocks in the upper level search area stored in the current search area storage unit 3. The SADs are obtained by substituting brightness values and coordinate values of respective points of the upper level basic blocks and brightness values and coordinate values of respective points of the upper level search area corresponding to the respective points of the upper level basic blocks into an equation for calculating an SAD. In general, the motion estimation is calculated only with brightness differences; however, it is understood that the motion estimation may also be calculated using luminescence, waves, etc.

When the SAD of every upper level basic block is calculated by the basic search unit 5, the current search area storage unit 3 shifts a storage position of the upper level search area by one pixel until the calculation of SADs on the upper level search area is completed. An area obtained by adding an area for the partial search, that is, a partial area, to a search area to be basically searched is stored in the current search area storage unit 3. The basic search unit 5 should search partial areas around the respective points in the search area to be basically searched, and the current search area storage unit 3 should store the upper level search area to which the partial areas are added so as to search the partial areas around the respective points at edges. In order to search all of the partial areas, the current search area storage unit 3 shifts the storage position of the upper level search area until the calculation of SADs on the partial area is completed. At that time, the storage position of the upper level search area should be shifted by one pixel as many times as are needed to cover the whole partial area.

When the storage position of the upper level search area is shifted by one pixel in the current search area storage unit 3, the basic search unit 5 calculates SADs between the respective upper level basic blocks and respective areas corresponding to the respective upper level basic blocks in the upper level search area shifted by one pixel. That is, since storage positions of the respective upper level basic blocks stored in the basic block storage unit 4 are fixed, and the storage position of the upper level search area stored in the current search area storage unit 3 is shifted, an effect of the partial search can be obtained only by allowing the basic search unit 5 to calculate the SADs between the input upper level basic blocks and the upper level search area.

When the calculation of SADs on the upper level search area is completed, the current search area storage unit 3 extracts another upper level search area that is different from the upper level search area from the search area, and stores the extracted another upper level search area, until the calculation of SADs on the search area is completed, that is, until the full search is completed. As the search area stored in the search area storage unit 2 is widened, the number of upper level search areas that should be extracted increases, and the aforementioned process is repeatedly performed on each of the extracted upper level search areas. That is, the basic search unit 5 calculates the SADs between the respective upper level basic blocks stored in the basic block storage unit 4 and respective areas corresponding to the upper level basic blocks in the another upper level search area stored in the current search area storage unit 3.

The SAD comparison unit 6 compares the SADs of the upper level basic blocks calculated by the basic search unit 5. That is, as described above, when the full search is completed by repeatedly using the basic search unit 5, the SAD comparison unit 6 compares the SADs that are results of the full search.

The address generating unit 7 generates addresses corresponding to search areas of C (=A+B) upper level candidate motion vectors indicated by A points having minimum SADs on the basis of a comparison result of the SAD comparison unit 6 and B points on the basis of spatial correlations between adjacent motion vectors. These addresses are addresses for extracting the search areas to be searched at the middle level from the search area storage unit 2. The candidate motion vectors obtained at the upper level and the candidate motion vector (to be described later) obtained at the middle level provide a reference for obtaining a final motion vector. That is, the upper level candidate motion vectors are fully searched with a low resolution in order to reduce the amount of calculation, and the middle level candidate motion vector is partially searched with a resolution slightly higher than the above low resolution in order to enhance accuracy, and the final motion vector is partially searched with an original resolution around the middle level candidate motion vector. Here, A is one or more, and B is zero or more. In other words, one point having the minimum SAD on the basis of the comparison result of the SAD comparison unit 6 necessarily becomes the upper level candidate motion vector, and the points obtained on the basis of the spatial correlations between motion vectors adjacent to the small SADs next to the minimum SAD become incidental upper level candidate motion vectors. By reducing the amount of calculation and enhancing the accuracy, the partial search is generally performed around two points having the minimum SAD and one point obtained on the basis of the spatial correlations between the motion vectors.

The current search area storage unit 3 extracts a middle level search area from the search area stored in the search area storage unit 2, and stores the extracted middle level search area. The extracted middle level search area is stored at the address corresponding to a search area of one upper level candidate motion vector of C upper level candidate motion vectors out of the addresses generated from the address generating unit 7, and has a resolution lower than that of the macro block and higher than that of the upper level search area. The middle level search is a process for searching, at a resolution between that of the upper level and that of the lower level, the middle level candidate motion vector, which serves is a reference for searching the final motion vector.

The basic block storage unit 4 extracts a middle level block having the same resolution as the middle level search area from the macro block stored in the macro block storage unit 1, separates as many middle level basic blocks as the number of simultaneous search units from the extracted middle level block, and stores the separated middle level basic blocks. Similar to the upper level search, since resolutions of both pictures to be mutually compared for motion estimation should be equal, the middle level block having the same resolution as the middle level search area is extracted.

The basic search unit 5 calculates SADs between the respective middle level basic blocks stored in the basic block storage unit 4 and the respective areas corresponding to the middle level basic blocks in the middle level search area stored in the current search area storage unit 3. Similar to the upper level search, the SADs are obtained by substituting brightness values and coordinate values of respective points of the middle level basic blocks and brightness values and coordinate values of respective points of the middle level search area corresponding directly to the respective points of the middle level basic blocks, into equations for calculating an SAD.

When the SAD of every middle level basic block is calculated by the basic search unit 5, the current search area storage unit 3 shifts a storage position of the middle level search area by one pixel until the calculation of SADs on the middle level search area is completed. Similar to the upper level search, the storage position of the middle level search area should be shifted by one pixel repeatedly until the partial area is completely covered.

When the storage position of the middle level search area is shifted by one pixel in the current search area storage unit 3, the basic search unit 5 calculates SADs between the respective middle level basic blocks and respective areas corresponding to the respective middle level basic blocks in the middle level search area shifted by one pixel.

The SAD merging unit 8 merges the SADs of the respective middle level basic blocks calculated by the basic search unit 5 to calculate SADs of the middle level block. Since the upper level basic blocks themselves are the macro block having a low resolution, the process of merging the SADs is not required. However, since the middle level basic blocks are separated from the macro block having a middle resolution, that is, the middle level block, the SADs of the respective middle level basic blocks should be merged, and the SAD of the middle level block should be calculated in order to obtain the motion vector of the macro block.

When the partial search of the middle level search area is completed, the current search area storage unit 3 extracts another middle level search area stored at an address corresponding to a search area of another candidate motion vector different from the candidate motion vector of the C upper level candidate motion vectors, and stores the extracted another middle level search area. In other words, when the another middle level search area is stored in the current search area storage unit 3, the basic search unit 5 calculates SADs between the respective middle level basic blocks stored in the basic block storage unit 4 and respective areas corresponding to the, middle level basic blocks in the another middle level search area stored in the current search area storage unit 3, and then the process is repeated.

The SAD comparison unit 6 compares the SADs of the middle level block calculated by the SAD merging unit 8. That is, as described above, when the partial searches are completed by repeatedly using the basic search unit 5, the SAD comparison unit 6 compares the SADs, which are results of the partial searches.

The address generating unit 7 generates an address corresponding to the search area of the middle level candidate motion vector indicated by a point having the minimum SAD on the basis of a comparison result of the SAD comparison unit 6. This address is an address for extracting a search area for the lower level search from the search area storage unit 2.

The current search area storage unit 3 extracts a lower level search area from the search area stored in the search area storage unit 2, and stores the extracted lower level search area. The extracted lower level search area has been stored at an address corresponding to a search area of the middle level candidate motion vector out of the addresses generated from the address generating unit 7, and has the same resolution as the macro block. The lower level search is a process for searching, at the original resolution, the final motion vector centering on the middle level candidate motion vector.

The basic block storage unit 4 separates a lower level block from the macro block stored in the macro block storage unit 1, separates as many lower level basic blocks as the number of simultaneous search units from the separated middle level block, and stores the separated lower level basic blocks. The resolution of the lower level block is equal to the resolution of the macro block.

The basic search unit 5 calculates SADs between the respective lower level basic blocks stored in the basic block storage unit 4 and the respective areas corresponding to the lower level basic blocks in the lower level search area stored in the current search area storage unit 3. Similar to the upper level search and the middle level search, the SADs are obtained by substituting brightness values and coordinate values of the respective points in the lower level basic blocks and brightness values and coordinate values of the respective points in the lower level search area corresponding directly to the respective points of the lower level basic blocks, into equations for calculating an SAD.

When the SAD of every lower level basic block is calculated by the basic search unit 5, the current search area storage unit 3 shifts a storage position of the lower level search area by one pixel until the calculation of SADs on the lower level search area is completed.

When the storage position of the lower level search area is shifted by one pixel in the current search area storage unit 3, the basic search unit 5 calculates SADs between the respective lower level basic blocks and the respective areas corresponding to the respective lower level basic blocks in the lower level search area shifted by one pixel. Similar to the upper level search and the middle level search, the storage position of the lower level search area should be shifted by one pixel repeatedly until the partial area is completely covered.

When the calculation of SADs on the lower level search area is completed, the basic block storage unit 4 separates another lower level block different from the lower level block from the macro block stored in the macro block storage unit 1 until the partial search of the whole macro block is completed, separates as many other lower level basic blocks as the number of simultaneous search units from the separated another lower level block, and stores the separated other lower level basic blocks. The aforementioned process is repeatedly performed on all the lower level blocks separated from the macro block. The basic search unit 5 calculates SADs between the respective other lower level basic blocks stored in the basic block storage unit 4 and the respective areas corresponding to the other lower level basic blocks in the lower level search area stored in the current search area storage unit 3.

The SAD merging unit 8 merges the SADs of the respective middle level basic blocks separated from the macro block to calculate SADs of various units of blocks. Therefore, the SADs of image blocks of various sizes required by H.264 can be calculated. In other words, in order to efficiently implement the fast motion estimation algorithm with hardware and calculate the SADs of image blocks of various sizes required by H.264, a block having the minimum size required by H.264 is set as a basic block, the SADs of the basic blocks are calculated by using repeatedly the basic block storage unit 4 and the basic search unit 5 for the basic blocks, and then the SADs are merged to calculate the SADs of image blocks of various sizes.

The best motion estimation block determining unit 9 determines a block of a mode performing the best motion estimation from the various units of blocks from which the SADs are calculated by the SAD merging unit 8. The number of SADs and the amount of data of each motion vector are adjusted to determine a block of a most efficient mode.

Now, a general example in which a size of a macro block is 16×16 and a size of a basic block is 4×4 is described. Here, the 4×4 basic block is the minimum block required by H.264. The number of simultaneous search units is set to 4.

The macro block storage unit 1 extracts a 16×16 macro block from a current frame, and stores the extracted 16×16 macro block.

The search area storage unit 2 extracts a search area of the 16×16 macro block from a previous frame, and stores the extracted search area. When a search is performed in a range of [−p, +p], the search area having a size of (16+2p)×(16+2p) is extracted. Here, the values of p are determined variably as 16, 32, 64, etc., in accordance with performance of an MPEG system. As the value of p increases, the area the search can be performed in increases, so that it is possible to perform a stable motion estimation when the motion is great.

The current search area storage unit 3 sub-samples the search area stored in the search area storage unit 2 to extract an upper level search area of which a vertical size and a horizontal size are decreased into a quarter, respectively, and stores the extracted upper level search area. A size of the upper level search area is set to 12×12 in consideration of the middle level and the lower level. The size of the upper level is equal to a size of data required for the search in a range of [−4, +4] for 4×4 blocks. The size of the upper level search area is not limited to 12×12.

When the number of simultaneous search units is set to 4, the basic block storage unit 4 is divided into four, i.e., a first basic block storage unit 41, a second basic block storage unit 42, a third basic block storage unit 43, and a fourth basic block storage unit 44. The basic search unit 5, which receives data from the basic block storage units, is also divided into four, that is, a first basic search unit 51, a second basic search unit 52, a third basic search unit 53, and a fourth basic search unit 54.

The first basic block storage unit 41 sub-samples a 16×16 macro block from the 16×16 macro block stored in the macro block storage unit 1 to extract a 4×4 upper level basic block of which a vertical size and a horizontal size are decreased into a quarter, respectively, and stores the extracted 4×4 upper level basic block.

The second basic block storage unit 42 sub-samples a 16×16 macro block from the 16×16 macro block stored in the macro block storage unit 1 to extract a 4×4 upper level basic block of which a vertical size and a horizontal size are decreased into a quarter, respectively, and stores the extracted 4×4 upper level basic block.

The third basic block storage unit 43 sub-samples a 16×16 macro block from the 16×16 macro block stored in the macro block storage unit 1 to extract a 4×4 upper level basic block of which a vertical size and a horizontal size are decreased into a quarter, respectively, and stores the extracted 4×4 upper level basic block.

The fourth basic block storage unit 44 sub-samples a 16×16 macro block from the 16×16 macro block stored in the macro block storage unit 1 to extract a 4×4 upper level basic block of which a vertical size and a horizontal size are decreased into a quarter, respectively, and stores the extracted 4×4 upper level basic block.

The first basic search unit 51 calculates SADs between the 4×4 upper level basic block stored in the first basic block storage unit 41 and an area corresponding to the 4×4 upper level basic block stored in the first basic block storage unit 41 in the 12×12 upper level search area stored in the current search area storage unit 3.

The second basic search unit 52 calculates SADs between the 4×4 upper level basic block stored in the second basic block storage unit 42 and an area corresponding to the 4×4 upper level basic block stored in the second basic block storage unit 42 in the 12×12 upper level search area stored in the current search area storage unit 3.

The third basic search unit 53 calculates SADs between the 4×4 upper level basic block stored in the third basic block storage unit 43 and an area corresponding to the 4×4 upper level basic block stored in the third basic block storage unit 43 in the 12×12 upper level search area stored in the current search area storage unit 3.

The fourth basic search unit 54 calculates SADs between the 4×4 upper level basic block stored in the fourth basic block storage unit 44 and an area corresponding to the 4×4 upper level basic block stored in the fourth basic block storage unit 44 in the 12×12 upper level search area stored in the current search area storage unit 3.

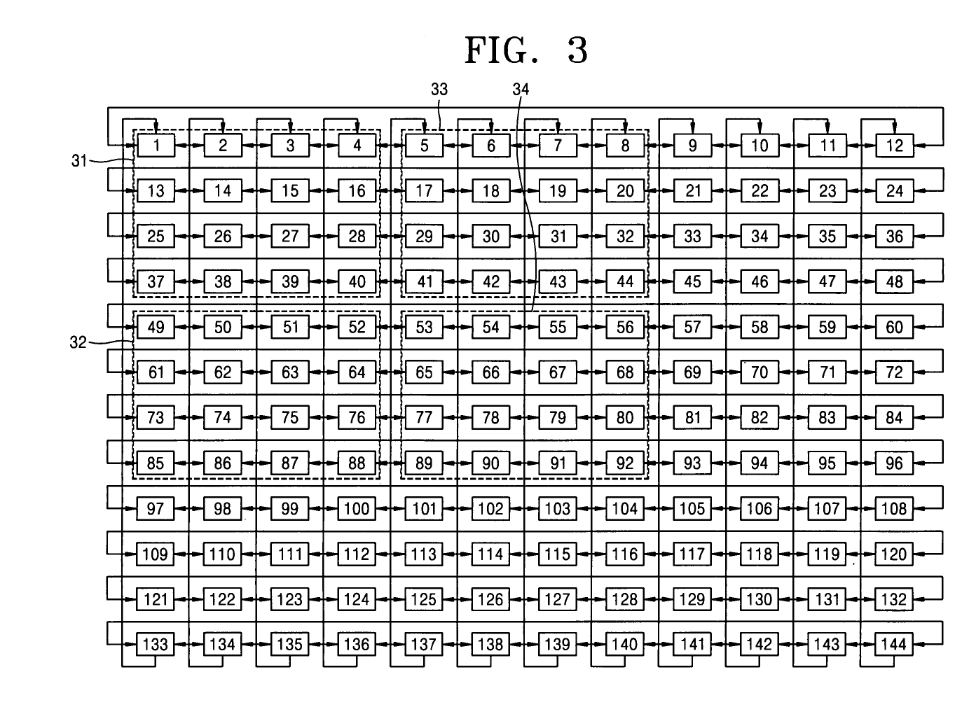

FIG. 3 is a diagram illustrating the basic blocks and the search area corresponding to the basic blocks according to an aspect of the invention. In FIG. 3, the whole 12×12 area is a search area, and four 4×4 square boxes are the basic blocks. The whole 12×12 area can be implemented out of a 12×12 register array, and the four 4×4 square boxes can be implemented out of 4×4 register arrays, respectively. In the basic blocks, the upper-left square box 31 includes pixels of the basic block stored in the first basic block storage unit 41, the lower-left square box 32 includes pixels of the basic block stored in the second basic block storage unit 42, the upper-right square box 33 includes pixels of the basic block stored in the third basic block storage unit 43, and the lower-right square box 34 includes pixels of the basic block stored in the fourth basic block storage unit 44. The upper-left square box 31 calculates an SAD between a pixel 1 of the basic block (4×4) and a pixel 1 of the search area (12×12), an SAD between a pixel 2 of the basic block and a pixel 2 of the search area, . . . , and an SAD between a pixel 40 of the basic block and a pixel 40 of the search area.

The lower-left square box 32, the upper-right square box 33 and the lower-right square box 34 are also SADs between pixels at the same positions, similarly. In other words, the SADs are calculated in a state where the four 4×4 register arrays are superposed on the 12×12 register array. The 12×12 register array has 144 registers which are indicated by the numbers 1 through 144, (1, 2, 3, 4, 13, 14, 15, 16, 25, 26, 27, 28, 37, 38, 39, 40) are associated with the first basic search unit 51, (5, 6, 7, 8, 17, 18, 19, 20, 29, 30, 31, 32, 41, 42, 43, 44) are associated with the second basic search unit 52, (49, 50, 51, 52, 61, 62, 63, 64, 73, 74, 75, 76, 85, 86, 87, 88) are associated with the third basic search unit 53, and (53, 54, 55, 56, 65, 66, 67, 68, 77, 78, 79, 80, 89, 90, 91, 92) are associated with the fourth basic search unit 54. The 144 registers are connected such that they can be shifted in a right and left direction in a column unit and in an up and down direction in a row unit.

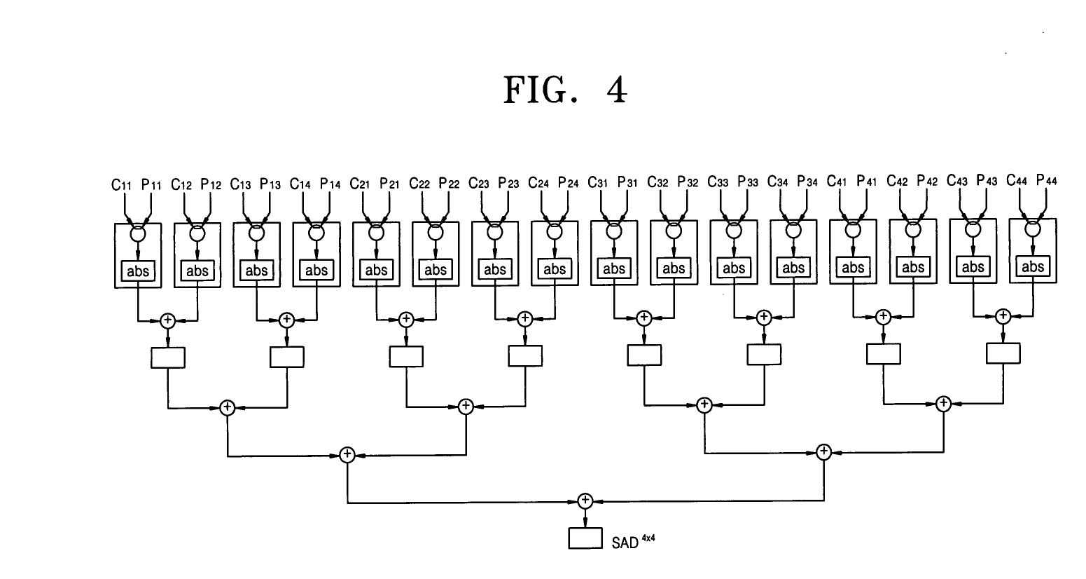

FIG. 4 is a diagram illustrating a structure of the basic search units shown in FIG. 2. In FIG. 4, each of the first basic search unit 51, the second basic search unit 52, the third basic search unit 53 and the fourth basic search unit 54 includes sixteen (16) absolute difference calculators and fifteen (15) adders.

C₁₁ is a brightness value of a pixel at a coordinate value of (1, 1) of the basic block, and C₁₂, etc. are similar thereto. P₁₁ is a brightness value of a pixel at a coordinate value of (1, 1) of the search area, and P₁₂, etc. are similar thereto. An absolute difference between C₁₁ and P₁₁ is calculated, and absolute differences between C₁₂ and P₁₂, etc. are calculated similarly thereto. That is, when the 16 brightness values of 16 pixels of each 4×4 basic block and the 16 brightness values of 16 pixels of the search area are simultaneously input to each of the first basic search unit 51, the second basic search unit 52, the third basic search unit 53 and the fourth basic search unit 54, the SADs₄₄ of the number of simultaneous search units, that is, four 4×4 basic blocks, are output at a time. In this way, by calculating the SADs₄₄ of the four basic blocks at a time, a fast motion estimating apparatus can be implemented.

When the SADs of all the upper level basic blocks are calculated by the first basic search unit 51, the second basic search unit 52, the third basic search unit 53 and the fourth basic search unit 54, the current search area storage unit 3 shifts the storage position of the upper level search area until the partial search is completed. Since the first basic search unit 51, the second basic search unit 52, the third basic search unit 53 and the fourth basic search unit 54 are able to search 8×8 pixels at a time and a space in which the search area is stored comprises a 12×12 register array, a range of the partial search is [−2, +2].

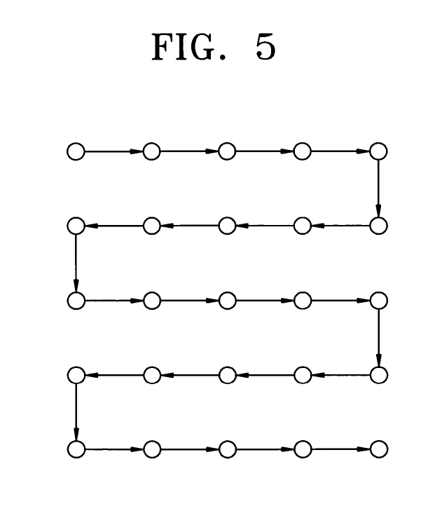

FIG. 5 is a diagram illustrating a search sequence of a partial search used according to an aspect of the invention. In FIG. 5, since the range of the partial search is [−2, +2], the partial search is performed on 5×5=25 points. The partial search proceeds in a winding or snake-like sequence, so that all the points in the range of [−2, +2] can be most efficiently searched. In addition to the illustrated search sequence, sequences from lower to upper, from left to right and from right to left or any combination thereof, are also possible.

When the storage position of the upper level search area is shifted by one pixel in the current search area storage unit 3, the first basic search unit 51 calculates the SAD between the 4×4 upper level basic block and an area corresponding to the 4×4 upper level basic block stored in the first basic block storage unit 41 in the 12×12 upper level search area shifted by one pixel.

When the storage position of the upper level search area is shifted by one pixel in the current search area storage unit 3, the second basic search unit 52 calculates the SAD between the 4×4 upper level basic block and an area corresponding to the 4×4 upper level basic block stored in the second basic block storage unit 42 in the 12×12 upper level search area shifted by one pixel.

When the storage position of the upper level search area is shifted by one pixel in the current search area storage unit 3, the third basic search unit 53 calculates the SAD between the 4×4 upper level basic block and an area corresponding to the 4×4 upper level basic block stored in the third basic block storage unit 43 in the 12×12 upper level search area shifted by one pixel.

When the storage position of the upper level search area is shifted by one pixel in the current search area storage unit 3, the fourth basic search unit 54 calculates the SAD between the 4×4 upper level basic block and an area corresponding to the 4×4 upper level basic block stored in the fourth basic block storage unit 44 in the 12×12 upper level search area shifted by one pixel.

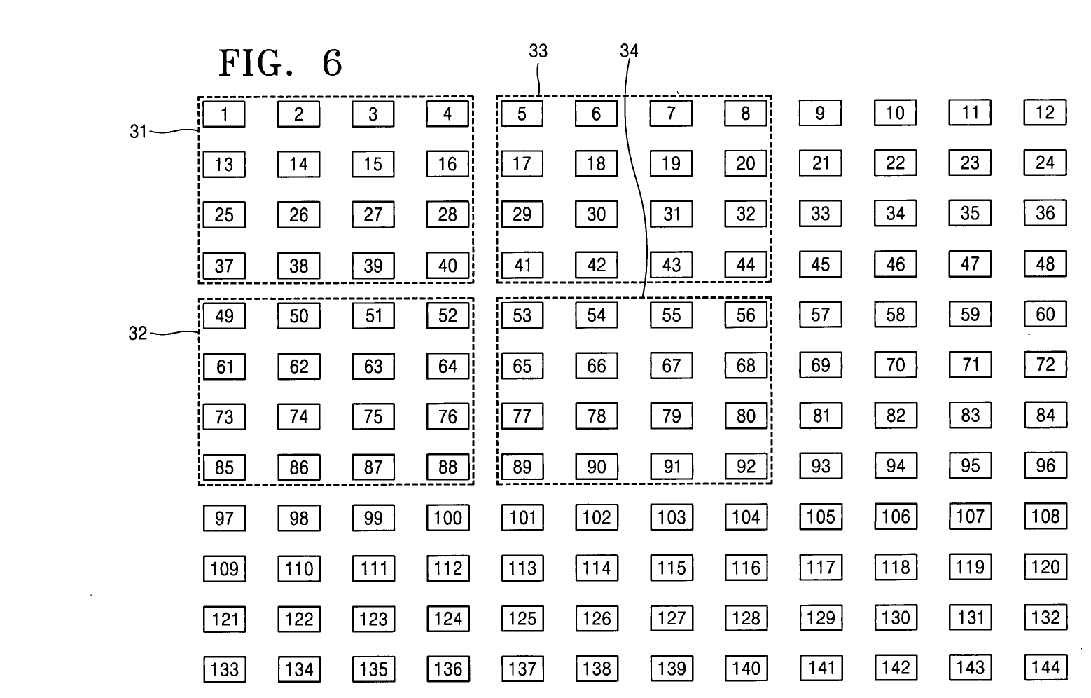

FIG. 6 is a diagram illustrating an array for calculating the SAD at a position of (−2, −2) in FIG. 5 according to an aspect of the invention.

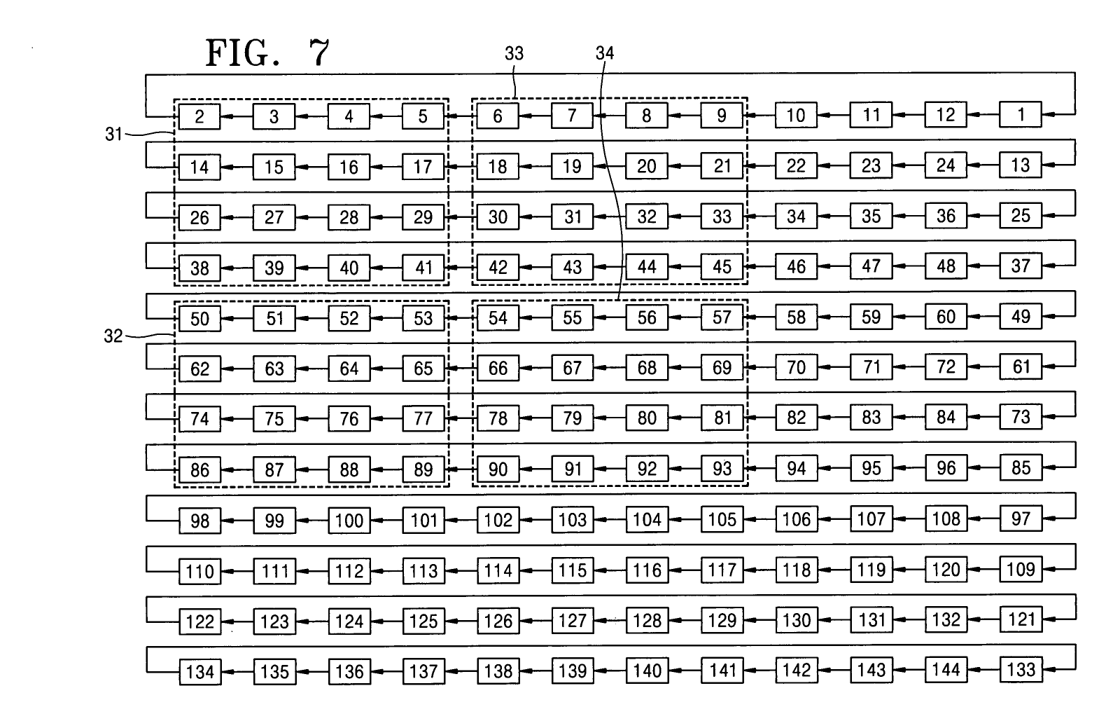

FIG. 7 is a diagram illustrating an array for calculating the SAD at a position of (−1, −2) in FIG. 5 according to an aspect of the invention.

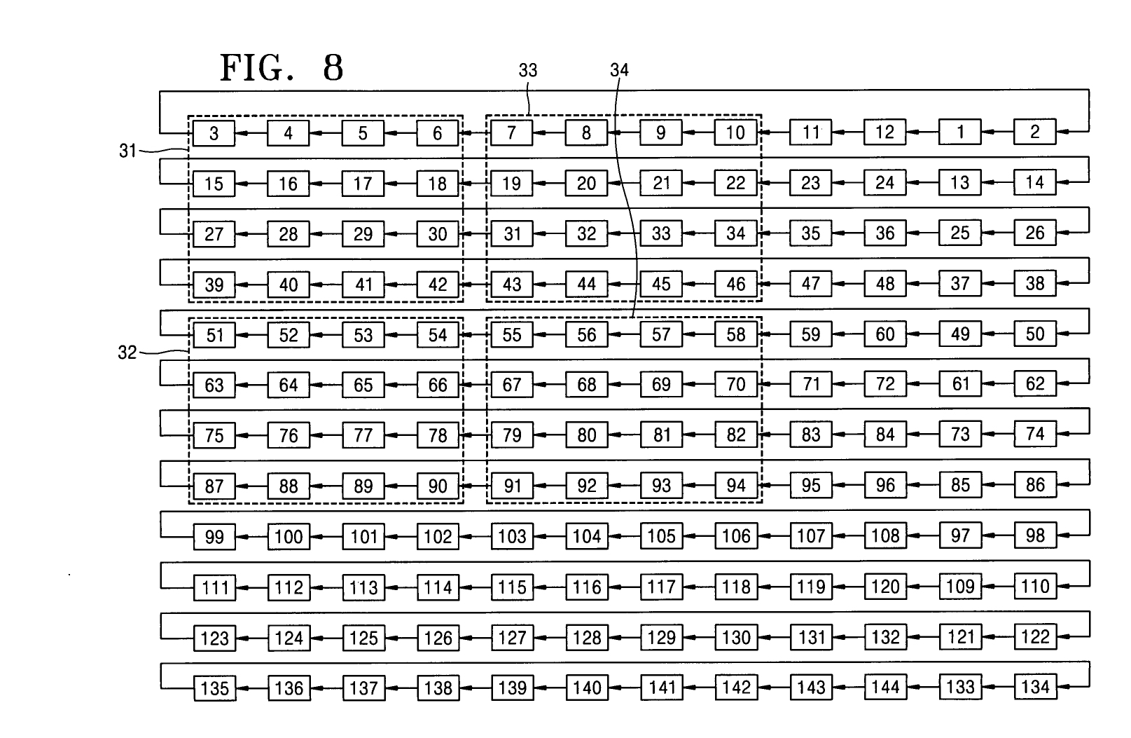

FIG. 8 is a diagram illustrating an array for calculating the SAD at a position of (0, −2) in FIG. 5 according to an aspect of the invention.

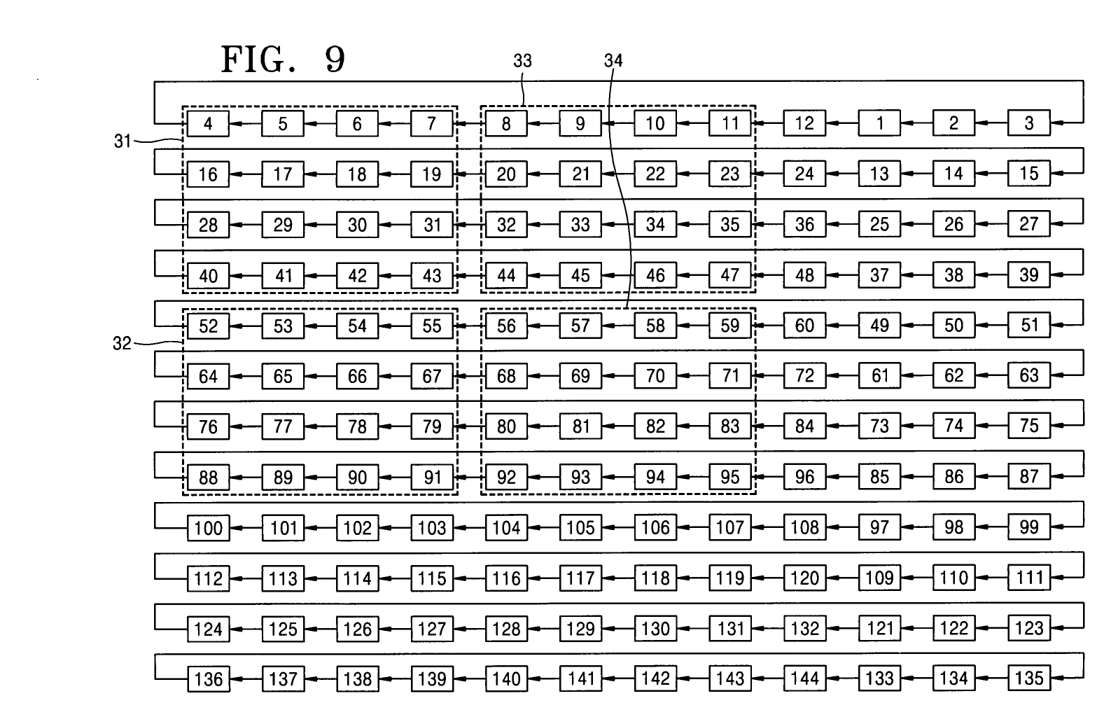

FIG. 9 is a diagram illustrating an array for calculating the SAD at a position of (1, −2) in FIG. 5 according to an aspect of the invention.

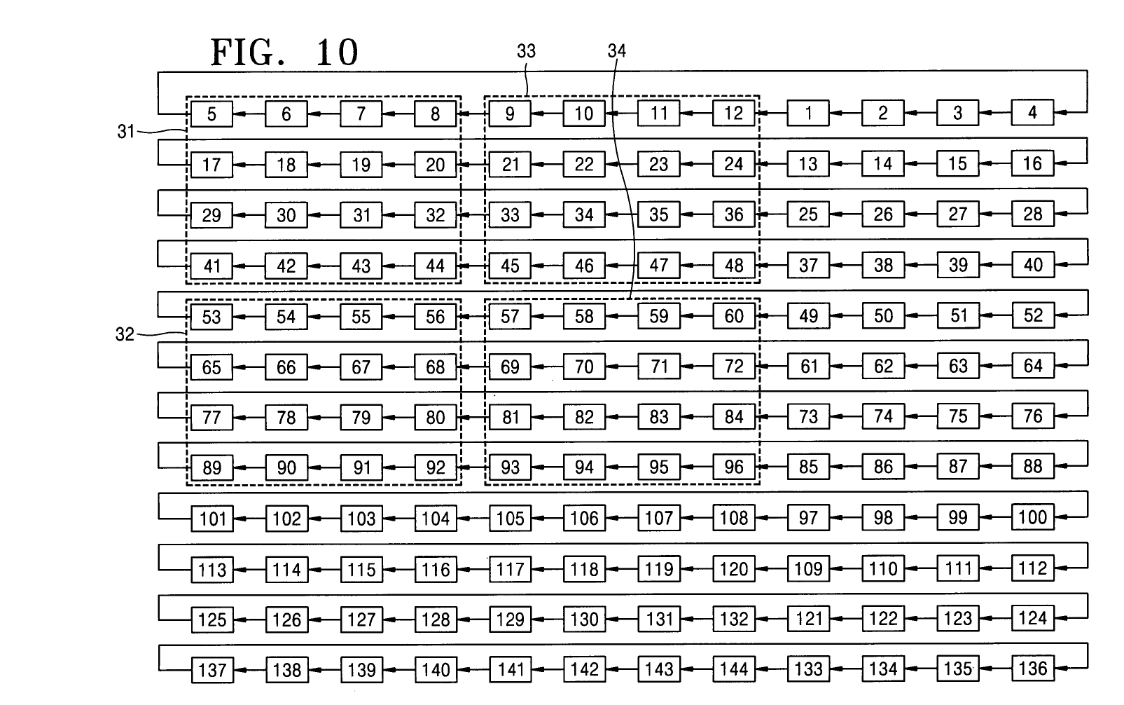

FIG. 10 is a diagram illustrating an array for calculating the SAD at a position of (2, −2) in FIG. 5 according to an aspect of the invention.

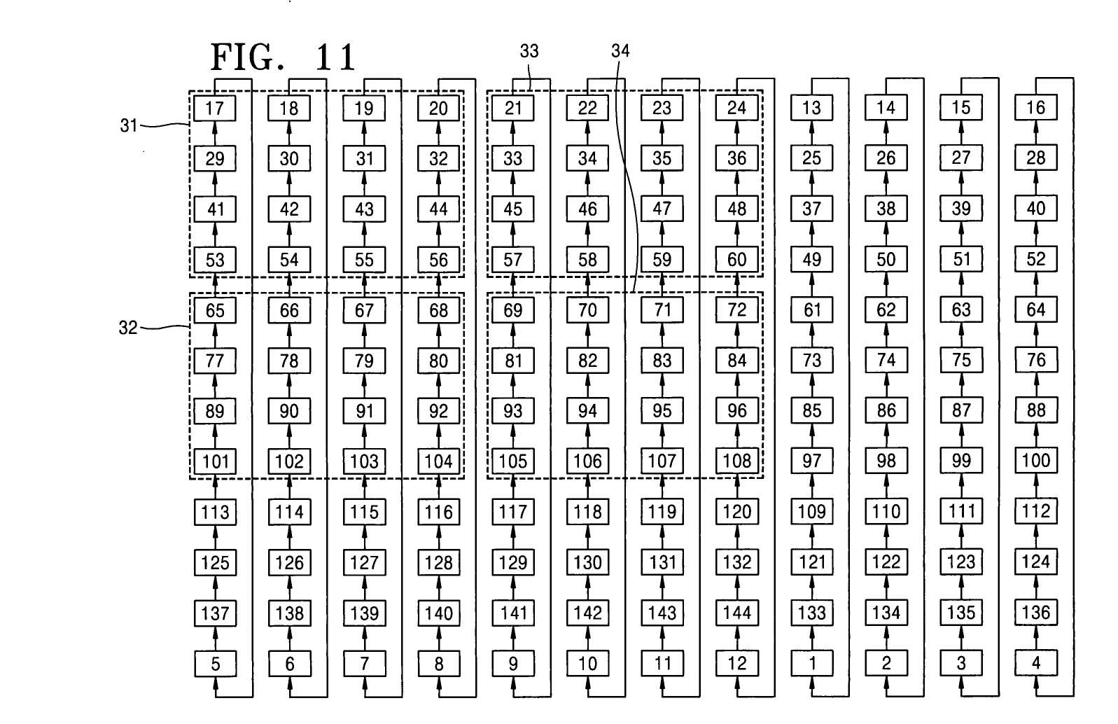

FIG. 11 is a diagram illustrating an array for calculating the SAD at a position of (2, −1) in FIG. 5 according to an aspect of the invention.

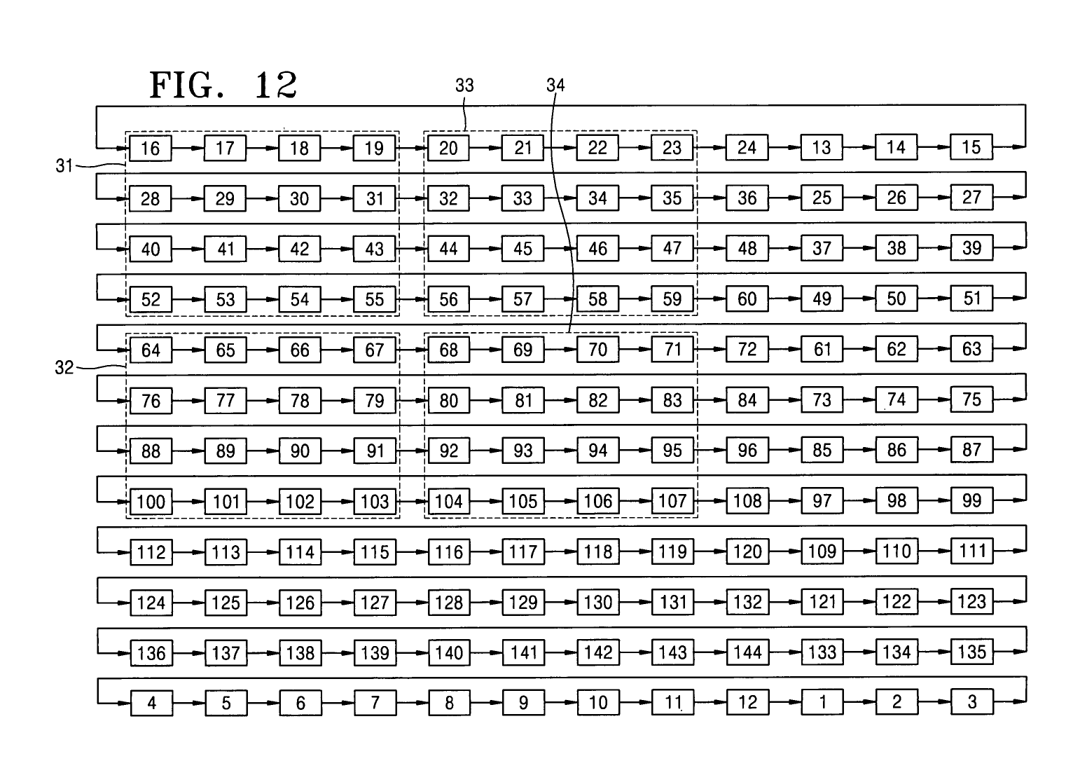

FIG. 12 is a diagram illustrating an array for calculating the SAD at a position of (1, −1) in FIG. 5 according to an aspect of the invention.

FIGS. 6, 7, 8, 9, 10, 11 and 12 illustrate arrays for calculating the SADs at six (6) points of the twenty-five (25) points shown in FIG. 5, respectively, and arrays for calculating the SADs at the other 19 points are similar thereto.

That is, FIGS. 6, 7, 8, 9, 10, 11 and 12 sequentially illustrate a data flow in the 12×12 register array for supplying proper data to the first basic search unit 51, the second basic search unit 52, the third basic search unit 53 and the fourth basic search unit 54 in order to perform the partial search in the range of [−2, +2]. As in FIG. 6, when the 12×12 register array is filled with the search area data, the first basic search unit 51, the second basic search unit 52, the third basic search unit 53 and the fourth basic search unit 54 calculate the SADs of the respective four 4×4 basic blocks at the position (−2, −2). Then, after one clock, as shown in FIG. 7, the 12×12 register array is shifted by one column to left to position the search area data corresponding to the position of (−1, −2) at the first basic search unit 51, the second basic search unit 52, the third basic search unit 53 and the fourth basic search unit 54. In this way, the 12×12 register array is shifted by one column to left every clock to sequentially calculate the SADs at the positions of (0, −2), (1, −2) and (2, −2). Subsequently, the 12×12 register array is shifted by one row upwardly as in FIG. 11 to calculate the SAD at the position of (2, −1). Subsequently, as in FIG. 12, the 12×12 register array is shifted by one column to right every clock to sequentially calculate the SADs at the positions of (1, −1), (0, −1), (−1, −1) and (−2, −1). In this way, after 25 clocks, the partial search of the four 4×4 basic blocks in the range of [−2, +2] can be completed.

When the partial search in the range of [−2, +2] is completed, the current search area storage unit 3 extracts another 12×12 upper level search area different from the 12×12 upper level search area from the search area until the full search is completed, and stores the extracted another 12×12 upper level search area. That is, until the search on the whole search area is completed, the search area is divided into several 12×12 upper level search areas, and the aforementioned process is repeatedly performed on the respective 12×12 upper level search areas, so that the SADs of the 4×4 basic blocks are calculated.

The SAD comparison unit 6 compares the SADs of the 4×4 upper level basic blocks calculated by the first basic search unit 51, the second basic search unit 52, the third basic search unit 53 and the fourth basic search unit 54.

The address generating unit 7 generates addresses corresponding to the search areas of the three upper level candidate motion vectors indicated by two points having the minimum SAD on the basis of the comparison result of the SAD comparison unit 6 and one point obtained on the basis of spatial correlations between the adjacent motion vectors.

The current search area storage unit 3 extracts the middle level search area from the search area stored in the search area storage unit 2, and stores the extracted middle level search area. The extracted middle level search area is stored at an address generated from the address generating unit 7, corresponding to a search area of any one upper level candidate motion vector of the three upper level candidate motion vectors, and has a resolution lower than that of the 16×16 macro block and higher than that of the 12×12 upper level search area. That is, the current search area storage unit 3 sub-samples a search area from the search area stored in the search area storage unit 2 to extract the 12×12 middle level search area of which a vertical size and a horizontal size are lessened into a half, respectively, and stores the extracted 12×12 middle level search area.

The first basic block storage unit 41 sub-samples a macro block from the macro block stored in the macro block storage unit 1 to extract an 8×8 middle level block of which a vertical size and a horizontal size are decreased in a half, respectively, separates a first 4×4 middle level basic block from the extracted 8×8 middle level block, and stores the separated first 4×4 middle level basic block.

The second basic block storage unit 42 sub-samples the macro block from the macro block stored in the macro block storage unit 1 to extract the 8×8 middle level block of which a vertical size and a horizontal size are lessened into a half, respectively, separates a second 4×4 middle level basic block from the extracted 8×8 middle level block, and stores the separated second 4×4 middle level basic block.

The third basic block storage unit 43 sub-samples the macro block from the macro block stored in the macro block storage unit 1 to extract the 8×8 middle level block of which a vertical size and a horizontal size are lessened into a half, respectively, separates a third 4×4 middle level basic block from the extracted 8×8 middle level block, and stores the separated third 4×4 middle level basic block.

The fourth basic block storage unit 44 sub-samples the macro block from the macro block stored in the macro block storage unit 1 to extract the 8×8 middle level block of which a vertical size and a horizontal size are lessened into a half, respectively, separates a fourth 4×4 middle level basic block from the extracted 8×8 middle level block, and stores the separated fourth 4×4 middle level basic block.

The first basic search unit 51 calculates an SAD between the first 4×4 middle level basic block stored in the first basic block storage unit 41 and an area corresponding to the first 4×4 middle level basic block in the 12×12 middle level search area stored in the current search area storage unit 3.

The second basic search unit 52 calculates an SAD between the second 4×4 middle level basic block stored in the second basic block storage unit 42 and an area corresponding to the second 4×4 middle level basic block in the 12×12 middle level search area stored in the current search area storage unit 3.

The third basic search unit 53 calculates an SAD between the third 4×4 middle level basic block stored in the third basic block storage unit 43 and an area corresponding to the third 4×4 middle level basic block in the 12×12 middle level search area stored in the current search area storage unit 3.

The fourth basic search unit 54 calculates an SAD between the fourth 4×4 middle level basic block stored in the fourth basic block storage unit 44 and an area corresponding to the fourth 4×4 middle level basic block in the 12×12 middle level search area stored in the current search area storage unit 3.

When the SADs on the first middle level basic block, the second middle level basic block, the third middle level basic block and the fourth middle level basic block are calculated by the first basic search unit 51, the second basic search unit 52, the third basic search unit 53 and the fourth basic search unit 54, respectively, the current search area storage unit 3 shifts the storage position of the middle level search area stored in the current search area storage unit 3 by one pixel, as in FIG. 5, until the partial search is completed.

When the storage position of the middle level search area in the current search area storage unit 3 is shifted by one pixel, the first basic search unit 51 calculates an SAD between the first 4×4 middle level basic block and an area corresponding to the first 4×4 middle level basic block in the 12×12 middle level search area shifted by one pixel. At that time, the second basic search unit 52, the third basic search unit 53 and the fourth basic search unit 54 calculate the SADs in the similar way.

When the calculation of SADs on the middle level search area having the range of [−2, +2] is completed, the SAD merging unit 8 merges the SADs on the respective 4×4 middle level basic blocks calculated by the first basic search unit 51, the second basic search unit 52, the third basic search unit 53 and the fourth basic search unit 54 to calculate the SAD of the 8×8 middle level block.

When the calculation of SADs on the middle level search area having the range of [−2, +2] is completed, the current search area storage unit 3 extracts another 12×12 middle level search area stored at an address corresponding to a search area of another upper level candidate motion vector, and stores the extracted another 12×12 middle level search area, until the searches on two upper level candidate motion vectors different from the aforementioned upper level candidate motion vector of the three upper level candidate motion vectors are completed. Therefore, in the middle level search, the first basic search unit 51, the second basic search unit 52, the third basic search unit 53 and the fourth basic search unit 54 are used a total of three times, respectively.

In this way, when the partial searches on the three upper level candidate motion vectors are completed, the SAD comparison unit 6 compares the SADs on the 8×8 middle level blocks calculated by the first basic search unit 51, the second basic search unit 52, the third basic search unit 53 and the fourth basic search unit 54.

The address generating unit 7 generates an address corresponding to a search area of one middle level candidate motion vector indicated by one point having the minimum SAD on the basis of the comparison result of the SAD comparison unit 6.

The current search area storage unit 3 extracts a 12×12 lower level search area from the search area stored in the search area storage unit 2, and stores the extracted 12×12 lower level search area. Here, the 12×12 lower level search area has been stored at the address, which is generated from the address generating unit 7, corresponding to the search area of the middle level candidate motion vector, and has the same resolution as the macro block.

The first basic block storage unit 41 separates a first 8×8 lower level block from the macro block stored in the macro block storage unit 1, separates a first 4×4 lower level basic block from the separated first 8×8 lower level block, and stores the separated first 4×4 lower level basic block. The 16×16 macro block is divided into a first 8×8 lower level block, a second 8×8 lower level block, a third 8×8 lower level block and a fourth 8×8 lower level block, and each 8×8 lower level block is divided into four 4×4 lower level basic blocks. That is, the 16×16 macro block is divided into a total of sixteen 4×4 lower level basic blocks.

The second basic block storage unit 42 separates the first 8×8 lower level block from the macro block stored in the macro block storage unit 1, separates a second 4×4 lower level basic block from the separated first 8×8 lower level block, and stores the separated second 4×4 lower level basic block.

The third basic block storage unit 43 separates the first 8×8 lower level block from the macro block stored in the macro block storage unit 1, separates a third 4×4 lower level basic block from the separated first 8×8 lower level block, and stores the separated third 4×4 lower level basic block.

The fourth basic block storage unit 44 separates the first 8×8 lower level block from the macro block stored in the macro block storage unit 1, separates a fourth 4×4 lower level basic block from the separated first 8×8 lower level block, and stores the separated fourth 4×4 lower level basic block.

The first basic search unit 51 calculates an SAD between the first 4×4 lower level basic block stored in the first basic block storage unit 41 and an area corresponding to the first 4×4 lower level basic block in the 12×12 lower level search area stored in the current search area storage unit 3.

The second basic search unit 52 calculates an SAD between the second 4×4 lower level basic block stored in the second basic block storage unit 42 and an area corresponding to the second 4×4 lower level basic block in the 12×12 lower level search area stored in the current search area storage unit 3.

The third basic search unit 53 calculates an SAD between the third 4×4 lower level basic block stored in the third basic block storage unit 43 and an area corresponding to the third 4×4 lower level basic block in the 12×12 lower level search area stored in the current search area storage unit 3.

The fourth basic search unit 54 calculates an SAD between the fourth 4×4 lower level basic block stored in the fourth basic block storage unit 44 and an area corresponding to the fourth 4×4 lower level basic block in the 12×12 lower level search area stored in the current search area storage unit 3.

When the SADs on the first 4×4 lower level basic block, the second 4×4 lower level basic block, the third 4×4 lower level basic block and the fourth 4×4 lower level basic block are calculated by the first basic search unit 51, the second basic search unit 52, the third basic search unit 53 and the fourth basic search unit 54, respectively, the current search area storage unit 3 shifts the storage position of the 12×12 lower level search area stored in the current search area storage unit 3 by one pixel, as in FIG. 5, until the calculation of SADs in the partial range of [−2, +2] is completed.

When the storage position of the 12×12 lower level search area in the current search area storage unit 3 is shifted by one pixel, the first basic search unit 51 calculates an SAD between the first 4×4 lower level basic block and an area corresponding to the first 4×4 lower level basic block in the 12×12 lower level search area shifted by one pixel. At that time, the second basic search unit 52, the third basic search unit 53 and the fourth basic search unit 54 also calculate the SADs in the similar ways.

When the calculation of SADs on the lower level search area having the range of [−2, +2] is completed, the first basic block storage unit 41 separates another 8×8 lower level block different from the first 8×8 lower level block, that is, any one of the second 8×8 lower level block, the third 8×8 lower level block and the fourth 8×8 lower level block, from the macro block stored in the macro block storage unit 1, separates a fifth 4×4 lower level basic block from the separated another 8×8 lower level block, and stores the separated fifth 4×4 lower level basic block, until the search on the macro block is completed. In the similar ways, the second basic block storage unit 42, the third basic block storage unit 43 and the fourth basic block storage unit 44 also stores a sixth 4×4 lower level basic block, a seventh 4×4 lower level basic block and an eighth 4×4 lower level basic block.

The SAD merging unit 8 merges the SADs of sixteen 4×4 lower level basic blocks calculated by the first basic search unit 51, the second basic search unit 52, the third basic search unit 53 and the fourth basic search unit 54 to calculate SADs of various units of blocks. That is, by using the SADs of the 4×4 basic blocks obtained from the first basic search unit 51, the second basic search unit 52, the third basic search unit 53 and the fourth basic search unit 54, the SADs of image blocks of various sizes, such as 8×4, 4×8, 8×8, 16×8, 8×16 and 16×16 can be obtained.

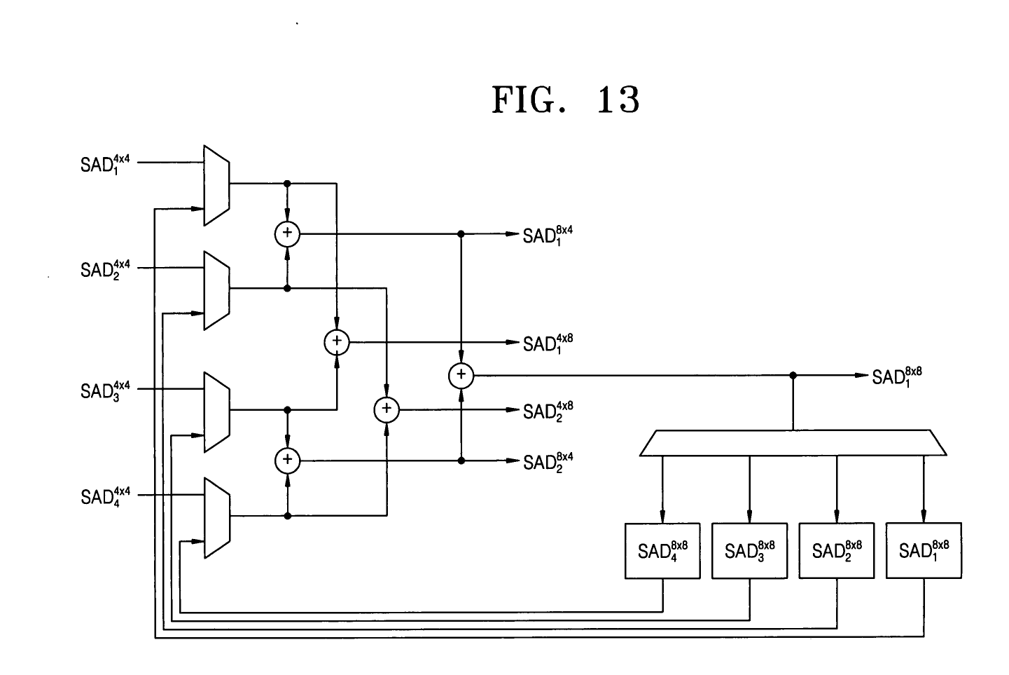

FIG. 13 is a block diagram illustrating a structure of the SAD merging unit shown in FIG. 2. In FIG. 13, the SAD merging unit 8 includes four multiplexers (MUX) which simultaneously receive two SADs, five adders which add the SADs, and four register arrays which stores the added SADs.

Four SADs simultaneously calculated by the first basic search unit 51, the second basic search unit 52, the third basic search unit 53 and the fourth basic search unit 54 are input to the four multiplexers MUX, respectively, and an 8×4 SAD₁, a 4×8 SAD₁, a 4×8 SAD₂, an 8×4 SAD₂, and an 8×8 SAD₁ are output. Here, the 8×8 SAD₁ is stored in one of the four registers, and is used at the next stages, so that it is finally possible to fast calculate the SADs of various sized of blocks required by H.264 at a faster rate. Since the minimum number of computing elements and memory elements are repeatedly used, the fast motion estimating apparatus according to the present invention can be usefully applied to mobile chips with small sizes and low power consumption.

The best motion estimation block determining unit 9 determines a block of a mode performing a best motion estimation from various units of blocks of which SADs are obtained from the SAD merging unit 8. That is, the best motion estimation block determining unit 9 determines blocks of a mode performing a best motion estimation with reference to the number of SADs of 8×4, 4×8, 8×8, 16×8, 8×16 and 16×16 blocks calculated by the SAD merging unit 8 and the amount of data of motion vectors. Here, determining blocks performing a best motion estimation indicates determining blocks performing a motion estimation with a smallest amount of data, among blocks of various sizes such as 8×4, 4×8, 8×8, 16×8, 8×16 and 16×16.

According to an aspect of the invention, since as many SADs are calculated at a time as the number of simultaneous search units, it is possible to implement a fast motion estimating apparatus using image blocks of various sizes in real time when the input picture has a standard definition (SD) format. In addition, by repeatedly using the minimum number of computing elements and memory elements, the fast motion estimating apparatus according the present invention can be usefully applied to mobile chips with small sizes and low power consumption.

Although a few embodiments of the present invention have been shown and described, it would be appreciated by those skilled in the art that changes may be made in these embodiments without departing from the principles and spirit of the invention, the scope of which is defined in the claims and their equivalents.

1. A fast motion estimating apparatus comprising:
a unit which merges differences of respective basic blocks extracted from a macro block to calculate differences of blocks of various sizes; and
a best motion estimation block determining unit which determines blocks performing a best motion estimation according to the calculated differences of the blocks of various sizes.

2. The apparatus according to claim 1, wherein the differences are sums of absolute differences.

3. The apparatus according to claim 1, further comprising:
a basic search unit which calculates differences of the respective basic blocks having a predetermined resolution extracted from the macro block and areas corresponding to the respective basic blocks in a sub-search area having the predetermined resolution extracted from a search area.

4. The apparatus according to claim 3, wherein the basic search unit calculates differences for a resolution that is lower than a resolution of the macro block, and calculates differences for the same resolution as the macro block when the search area is reduced according to the calculated differences for the lower resolution.

5. The apparatus according to claim 4, comprising:
a current search area storage unit to extract the sub-search area having the predetermined resolution from the search area and store the extracted sub-search area; and
a basic block storage unit to extract basic blocks having the predetermined resolution from the macro block and storing the extracted basic blocks,
wherein the basic search unit calculates differences of the respective basic blocks stored in the basic block storage unit and the areas corresponding to the respective blocks in the search area of a predetermined level stored in the current search area storage unit.

6. The apparatus according to claim 4, further comprising:
a current search area storage unit which repeatedly shifts a storage position of the search area by one pixel until the calculation of differences for the search area is complete whenever the difference of every basic block is calculated in the basic search unit,
wherein the basic search unit calculates differences of the respective basic blocks and the areas corresponding to the respective blocks in the search area shifted by one pixel.

7. The apparatus according to claim 1, wherein the unit which merges differences of respective basic blocks extracted from the macro block to calculate differences of the blocks of various sizes merges the sums of absolute differences of the respective sixteen 4×4 basic blocks that are separated from the 16×16 macro block to calculate the sums of absolute differences of at least one of an 8×4 block, a 4×8 block, an 8×8 block, a 16×8 block, an 8×16 block, and a 16×16 block.

8. A method of estimating motion of a moving object in a video sequence, comprising:
extracting basic blocks from a macro block according to a predetermined resolution;
merging differences of the extracted basic blocks, respectively, to calculate differences of blocks of various sizes; and
determining which blocks perform a best motion estimation according to the calculated differences of the blocks of various sizes.

9. The method of estimating motion of the moving object in the video sequence as claimed in claim 8, wherein the differences are sums of absolute differences.

10. The method of estimating motion of the moving object in the video sequence as claimed in claim 8, further comprising:
calculating differences of the respective basic blocks having the predetermined resolution extracted from the macro block and areas corresponding to the respective basic blocks in a sub-search area having the predetermined resolution extracted from a search area.

11. The method of estimating motion of the moving object in the video sequence as claimed in claim 10, further comprising:
calculating differences for a resolution that is lower than a resolution of the macro block, and calculating differences for the same resolution as the macro block when the search area is reduced according to the calculated differences for the lower resolution.

12. The method of estimating motion of the moving object in the video sequence as claimed in claim 10, further comprising:
repeatedly shifting a position of the search area by one pixel until the calculation of differences for the search area is complete,
wherein the basic search unit calculates differences of the respective basic blocks and the areas corresponding to the respective blocks in the search area shifted by one pixel.

13. A fast motion estimating apparatus to perform a fast motion estimation algorithm for a video sequence, comprising:
a plurality of levels of an image stacked together, each of the plurality of levels is one-half the size of a preceding level in the stack in both a horizontal and a vertical dimension; and
a search unit to perform a full search at the smallest size level, and subsequently perform partial searches at the remaining levels in the stack by using motion vectors obtained from a previous level as search points,
wherein a search point having a value equal to a minimum calculated sum of absolute difference at each of the plurality of levels is selected as an initial search point for one of the plurality of levels of the image.

14. The fast motion estimating apparatus to perform the fast motion estimation algorithm as claimed in claim 13 wherein the plurality of levels of the image comprise:
a lower level layer having an original image size;
a middle level layer that is one-half of the original image size; and
an upper level layer that is one-quarter of the original image size,
wherein the full search is performed at the upper level layer and the partial searches are performed at the lower level layer and the middle level layer.

15. The fast motion estimating apparatus to perform the fast motion estimation algorithm as claimed in claim 14, wherein there are three search points such that two of search points are selected from the upper level search and the other search point is selected according to spatial correlations between the motion vectors.
